(19) United States
(12) Patent Application Publication
(10) Pub. No.: US 2011/0160512 A1
(43) Pub. Date: Jun. 30, 2011

(54) METHOD OF PREPARATION OF ZnS AND CdS NANOPARTICLES FOR DECHLORINATION OF POLYCHLOROBIPHENYLS IN OILS

(76) Inventors: MEHRAN GHIACI, ISFAHAN (IR); Ryhaneh Nasr Esfahany, ISFAHAN (IR)

(21) Appl. No.: 13/043,788

(22) Filed: Mar. 9, 2011

(51) Int. Cl. A62D 3/176; B01J 37/30; B01J 21/16; A62D 3/10; B82Y 30/00

(52) U.S. Cl. 588/309; 502/11; 502/80; 588/301; 977/903

(57) ABSTRACT

The various embodiments herein provide a method of preparation of a nano-material for dechlorination of polychlorobiphenyls (PCB) from oil. The method involves preparing a modified bentonite prepared by treating with hexadecyl pyridinium bromide surfactant and dispersing the modified bentonite in cyclohexane. Aqueous solutions of metal ion such as Cadmium Nitrate or Zinc Nitrate and sulfide ions such as sodium sulfide are added alternately to obtain metal sulphide nano-particles. zinc nitrate is more preferable. The method of dechlorination of polychlorobiphenyls from oil involves irradiating a mixture of oil, nano-material and a solvent such as toluene under UV light for 2-6 h. A nano-material including a modified bentonite with a mono-layer of surfactant and metal sulphide nano-particles such as ZnS and CdS for remediation of oil containing PCB, is also provided.

### SPONSORSHIP STATEMENT

The present invention for international filing is sponsored by The Iranian Nanotechnology initiative Council.

### BACKGROUND

1. Technical Field

The embodiments herein generally relate to a method of preparation of ZnS and CdS nanoparticles and particularly to a method of preparation of ZnS and CdS nanoparticles immobilized on a modified bentonite system. The embodiments herein particularly relate a method for remediation of oils containing harmful polychlorinated biphenyls or PCBs using the immobilized ZnS and CdS nanoparticles.

2. Description of the Related Art

Given the importance of decreasing the size of well-known substances to nano-metric particles, in order to produce new materials or to realize nano-devices or nano-machines, much effort has been devoted to develop new synthesizing methods for producing size-controlled nano-particles. Since nano-particles are thermodynamically unstable against unlimited growth, their synthesis requires suitable conditions in order to achieve their formation but to inhibit their growth. The physico-chemical processes generally used to obtain size control are: (a) charging of the particle; (b) adsorption of suitable molecules at the nano-particle surface and (c) compartmentalization of nano-particles in spatially distinct domains.

Among the various methods used to produce nano-particles, it has been proposed to use water: oil (w:o) micro-emulsions as solvent and reaction media to synthesize and to stabilize solid nano-particles. The reversed micelles characterizing the microstructure of w:o micro-emulsions are, in principle, capable of hosting solid nano-particles, obtained in situ by suitable reactions, in their hydrophilic core to prevent nuclei agglomeration and precipitation. In fact, the material exchange process occurring on the millisecond time scale allows hydrophilic reactants to come rapidly in contact and react whereas the closed structure of reversed micelles and their dispersion in a non-polar environment can inhibit the unlimited growth of nano-particles. Since it is very important for technological applications to have a capability to produce mono-disperse and stable nano-particles, investigations of the time evolution of physico-chemical properties of nano-particles in w:o micro-emulsions are pivotal. Due to the importance of finely subdivided zinc sulphide (ZnS) as a phosphor in thin film electroluminescent devices for the photochemical production of hydrogen solar cells and IR windows, the formation of ZnS nano-particles in w:o micro-emulsions has recently been reported. The results of a calorimetric investigation pointed out that the energetic state of ZnS nano-particles confined in the aqueous core of the reversed micelles is different from that in water, and is also dependent on specific interactions between nano-particles and the water: surfactant interface. Researchers have done extensive work on the production of nanoparticles within the solid/liquid interfacial adsorption layer.

Previous studies have shown that modified bentonite has a strong ability to adsorb organic compounds from aqueous solutions, and literature reports indicate that ZnS and CdS could be used as semiconductor-type photocatalysts for photoreductive degradation of water pollutants. More recently, nano-scale photo reactive catalysts of TiO₂ and other compounds such as MoS₂, SnO₂, ZnS and mixed systems have been investigated for the degradation of organic compounds. These compounds are of interest because they allow tuning of the HOMO-LUMO transition towards the visible region of the spectrum, versus ultraviolet for bulk particles, and they have increased catalytic efficiencies because of the larger surface area found in nano-particles.

Spectroscopy and photo-catalysis involving nano-particles have received increased attention in the literature due to the new properties they have exhibited as a result of quantum confinement. These quantum effects begin to appear when materials become smaller than the Bohr exciting radius, generally with diameters around 100 nm or less. Quantum confinement and surface effects dominate the optical and catalytic properties of such compounds. Nano-size semiconductor photo-catalysts have been observed to be more effective than their bulk counterparts for numerous reasons including increased surface area, lower scattering, increased photo-stability and ability to tune absorbance wavelength to allow more of the sun-spectrum for use in photo-catalysis and photo-remediation.

The removal of pollutants from an environment is an ongoing and important problem. Many different protocols have been considered with various degrees of success. Bringing of the soils and groundwater contaminated with chlorinated hydrocarbons into a proper form is valuable because of the potential carcinogenic nature of these compounds and the products of degradation and their resistance to natural degradation in the environment. The polychlorinated biphenyls that are injurious to human bodies and chemically very stable, were found to cause environmental pollution and to be stored in a high concentration within living beings through food chains. When released into the environment, PCBs are adsorbed to particulate matters that can be dispersed over long areas.

The degradation of polychlorinated biphenyls (PCBs) and other chlorinated aromatic hydrocarbons are of great concern due to their toxicity and persistence in the environment. As a matter of fact, the polychlorinated biphenyls, were used in hundreds of industrial applications (e.g., in electrical transformers, machine oils and as plasticizers in paints and plastics) for their non-flammability, stability and electrical insulating properties. Several million tones of polychlorinated biphenyls were produced in the developed countries from its first industrial use in 1927 to the cessation of production in 1977 in the United States of America and probably since that time a total of about million tones of this product have been stored in the world. The concentration of PCBs in the material to be treated generally ranges from 0.001% by weight up to 100% by weight. Clearly, PCBs are often contained in oils such as insulating oils composed of mineral oils and alkylbenzenes. Although the use of PCBs has been banned by environmental agencies in different countries, but these harmful products might be used silently in the developing countries.

For more than three decades, it has been a highly challenging task to remediate oils containing polychlorinated biphenyls. Among the numerous remediation technologies, an abiotic dechlorination process using zero-valent iron has seduced increasing interest. In recent years, commercial granular iron particles have been employed to degrade chlorinated hydrocarbons. However, because of limited reactivity, the dechlorination rate using iron particles was often too slow to be practically successful. In this regard, different modification was employed to improve the reactivity of granular iron particles. One was to decrease the particle size, which in turn increases the particle surface area. Clearly, the dechlorination reaction occurs on the surface of nanoparticles, therefore one expect the increasing of the surface area results in enhanced reaction kinetics. In another modification, iron particles were coated with a small quantity of a catalytic metal such as palladium. On the other hand, this improvement increased the reactivity of the catalyst and even decreased the formation of the toxic intermediate by-products.

The established methods hitherto proposed for the decomposition of polychlorinated hydrocarbons such as PCBs include the following methods: combustion at a temperature of at least 1100° C., catalytic hydrogenation, photochemical decomposition with UV light and biological decomposition using microorganisms. These methods are not really satisfactory with respect to energy consumption, treatment time, and equipment cost or formation by-products. In other words, all these methods require long processing times and/or very high temperatures for the dechlorination to occur and are not practical especially in developing countries and usually end up being very expensive. Thus it is of utmost importance to develop a method that remediates PCBs contaminated oil, soils and waters in a most economic manner.

While the pros and cons of these technologies have been demonstrated, there remains a strong need for developing more cost effective technology to destroy chlorinated hydrocarbons in a simple manner easily without requiring a complex process.

The above mentioned shortcomings, disadvantages and problems are addressed herein and which will be understood by reading and studying the following specification.

### OBJECTIVES OF THE EMBODIMENTS

The primary object of the embodiments herein is to provide a method for effectively decomposing chlorinated hydrocarbons especially polychlorinated hydrocarbons easily, quickly and cheaply.

Another object of the embodiments herein is to provide a method that will decompose PCBs while recovering the oil.

Yet another object of the embodiments herein is to provide a method that is devoid of the drawbacks of the conventional methods.

Yet another object of the embodiments herein is to provide a method that can be performed at room temperature.

Yet another object of the embodiments herein is to provide a method that uses a catalyst which can be prepared easily on a cheap support like bentonite and can be reused for at least 2-3 times after disposing.

Yet another object of the embodiments herein is to provide a method that is industrially suitable.

These and other objects and advantages of the embodiments herein will become readily apparent from the following detailed description taken in conjunction with the accompanying drawings.

### SUMMARY

The various embodiments of the invention provide a bentonite system which is modified with a surfactant, and is used as a support for immobilization of ZnS and CdS nanoparticles. The embodiments herein also relate to zinc or cadmium nano-materials immobilized on the modified bentonite, methods for their preparation and methods for using them for remediation of oils containing harmful polychlorinated biphenyls (PCBs). A stabilized, chemically reactive zinc or cadmium sulfide nano-material effective for degradation of chlorinated biphenyls compounds in PCB oils, transformers, or capacitors is prepared. The nano-materials are composed of zinc or cadmium sulfide nanoparticles that are dispersed on the surface of a modified organo-bentonite. The preferred nanoparticles are zinc sulfides and the preferred surfactant for modification of the Na-bentonite is cetylpyridinium bromide. A method of making the sulfide nano-materials is further disclosed wherein a solution of the metal ion and sulphideion is added alternatively, to a suspension of the modified bentonite in cyclohexane. A process for reductive chlorination of polychlorinated biphenyls is also disclosed wherein the resulting CdS-bentonite and ZnS-bentonite nano-composites can degrade PCBs from oils after 6 h under UV irradiation.

According to an embodiment herein, a method of preparation of a nano-material for dechlorination of polychlorobiphenyls (PCB) from oil comprising the steps wherein a modified bentonite is prepared. The prepared modified bentonite is dispersed in a non-polar medium. The aqueous solution of metal ion and aqueous solution of sulfide ion are added alternatively to the dispersed modified bentonite suspension at room temperature for 24 h. The nano-particles of metal sulphide are formed thus producing the nano-material. The modified bentonite is prepared by treating a Na-bentonite with an aqueous solution of a surfactant at room temperature. The surfactant herein is selected from a group consisting of hexadecyl pyridinium bromide (HDPB) and hexadecyl trimethyl ammonium bromide (HDTMAB), wherein hexadecyl pyridinium bromide is more preferable. The non-polar medium herein is cyclohexane. The aqueous solution of metal ion is selected from a group consisting of Cadmium Nitrate or Zinc Nitrate, wherein zinc nitrate is more preferable. The aqueous solution of sulfide ion herein is Sodium sulfide. The nano-particles of metal sulphide are selected from a group consisting of ZnS and CdS nano-particles immobilized on a surface of the modified bentonite.

According to one embodiment herein, a method for dechlorination of oil comprises mixing the oil, the nano-material and a solvent. Then, the mixture is irradiated under ultraviolet rays for 2-6 h. The oil is selected from a group consisting of PCB oil, transformer oil and capacitor oil. The solvent herein is toluene.

According to one embodiment herein, a nano-material comprises a modified bentonite, a surfactant mono-layer and metal sulphide nano-particles. The modified bentonite is prepared by treating a Na-bentonite with an aqueous solution of a surfactant at room temperature. The surfactant is of hexadecyl pyridinium bromide (HDPB) and hexadecyl trimethyl ammonium bromide (HDTMAB), wherein hexadecyl pyridinium bromide is more preferable. The metal sulphide nano-particles are selected from a group consisting of ZnS and CdS. The metal sulphide nano-particles are immobilized on the surface of modified bentonite.

According to one embodiment herein, a heterogeneous system includes a solvent phase having a solvent and oil and a solid phase having modified bentonite and nano or microscale sulphide particles. The solvent is toluene, hexanes or the like.

According to one embodiment herein, a method of destroying PCBs from an oil mixture is provided. The method includes applying a two-phase system and wherein the solid phase includes a modified bentonite and nano or microscale sulphide particles. The liquid phase includes a hydrophobic solvent and the oil.

According to one embodiment herein, a method of modifying the bentonite and immobilization of the nano and microscale sulphide particles.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flow chart indicating the steps in a method of preparation of a nano-material for dechlorination of polychlorobiphenyls (PCB) from oil, according to an embodiment herein.

FIG. 2 illustrates a step by step diagrammatic representation of the formation of ZnS nano-particles on the surface of modified bentonite, according to an embodiment herein.

FIG. 3 illustrates a schematic presentation of a modified bentonite with metal ion and surfactant molecules, according to an embodiment herein.

FIG. 4A shows a micrograph of parent bentonite obtained using a Scanning Electron Microscopic (SEM), according to an embodiment herein.

FIG. 4B shows a micrograph of bentonite modified with a monolayer of a surfactant (BMS), obtained using a SEM, according to an embodiment herein.

FIG. 4C shows a SEM micrograph of Zinc Sulphide nanoparticles-bentonite composite, according to an embodiment herein.

FIG. 4D shows a SEM micrograph of Zinc Sulphide nanoparticles-bentonite composite, according to an embodiment herein.

FIG. 4E shows an Energy-dispersive X-ray spectroscopy (EDS) spectrum of prepared modified bentonite with Zinc Sulphide nano-particles and surfactant, according to an embodiment herein.

FIG. 5A shows a Transmission Electron Microscopy (TEM) micrograph of Zinc sulphide modified bentonite, according to an embodiment herein.

FIG. 5B shows a TEM micrograph of Zinc sulphide modified bentonite, according to an embodiment herein.

FIG. 5C shows a TEM micrograph of Zinc sulphide modified bentonite, according to an embodiment herein.

FIG. 5D shows a TEM micrograph of Zinc sulphide modified bentonite, according to an embodiment herein.

FIG. 5E shows an EDS spectrum of Zinc sulphide modified bentonite, according to an embodiment herein.

FIG. 6A shows a TEM micrograph of Cadmium sulphide modified bentonite, according to an embodiment herein.

FIG. 6B shows a TEM micrograph of Cadmium sulphide modified bentonite, as an embodiment herein.

FIG. 6C shows an EDS spectrum of Cadmium sulphide modified bentonite, according to an embodiment herein.

FIG. 7A shows an Atomic force microscopy (AFM) image of Zinc sulphide nano-particles immobilized on the surface of modified bentonite, according to an embodiment herein.

FIG. 7B shows an AFM image of Zinc sulphide nano-particles immobilized on the surface of modified bentonite, according to an embodiment herein.

FIG. 7C shows an AFM image of cadmium sulphide nano-particles immobilized on the surface of modified bentonite, according to an embodiment herein.

FIG. 7D shows an AFM image of cadmium sulphide nano-particles immobilized on the surface of modified bentonite, according to an embodiment herein.

FIG. 8 shows a UV-Visible spectra of bentonite, Zinc sulphide bentonite and Cadmium bentonite, according to an embodiment herein, wherein (a) is bentonite, (b) is Zinc sulphide bentonite and (c) is Cadmium bentonite.

FIG. 9A shows a chromatograph of one test mixture of the oil containing polychlorinated biphenyls.

FIG. 9B shows a chromatograph of one test mixture after exposing to the Zinc sulphide nano-particles in the presence of UV light.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

Polychlorinated biphenyls or PCBs are often contained in oils such as insulating oils composed of mineral oils and alkylbenzenes. Such PCB-containing oils can be suitably treated by the method of the embodiments herein, while recovering the oil.

According to an embodiment herein, a method of preparation of a sulphide nano-material for dechlorination of polychlorobiphenyls (PCB) from an oil comprising the steps of preparing a modified bentonite at a preset temperature and wherein the preset temperature is room temperature, dispersing the prepared modified bentonite in a non-polar medium and adding an aqueous solution of a metal ion and an aqueous solution of a sulphide ion alternatively to the dispersed modified bentonite suspension at a given temperature for a preset period. The given temperature is a room temperature and the preset period is 24 h. Then nano-particles of metal sulphide are formed so that the nanoparticles are formed and immobilized on a surface of the modified bentonite.

The modified bentonite is prepared by treating a Na-bentonite with an aqueous solution of a surfactant at room temperature. The surfactant is selected from a group consisting of hexadecyl pyridinium bromide and hexadecyl trimethyl ammonium bromide. The surfactant is hexadecyl pyridinium bromide.

The non-polar medium is cyclohexane. The metal ion is selected from a group consisting of Cadmium Nitrate and Zinc Nitrate. The metal ion is Zinc Nitrate. The sulphide ion is Sodium Sulphide. The nano-particles of metal sulphide are selected from a group consisting of nano particles of ZnS and nano-particles of CdS. The nano-particles of metal sulphide are ZnS nanoparticles.

According to an embodiment herein, a method is provided for reductive chlorination of polychlorobiphenyls (PCB) from an oil. The method comprising the steps of preparing a metallic catalyst. The metallic catalyst is nanoparticles of ZnS immobilised on a modified bentonite surface. The metallic catalyst, a solvent and the oil to be reductively chlorinated are mixed to form a suspension. The suspension is irradiated for a given time. The given time is for 2-6 h. The step of irradiating the suspension involves irradiating the suspension using an ultraviolet light. The suspension is irradiated using an ultraviolet lamp.

The oil is selected from a group consisting of PCB oil, transformer oil and capacitor oil. The metallic catalyst is a Zinc sulphide nano-particle immobilized on a modified bentonite surface. The solvent is toluene. The metallic catalyst is reused for 2-3 times before being disposed of

The method further comprising a step of applying a two phase system to destroy PCB from an oil mixture. The two phase system includes a solid phase and a liquid phase to form an emulsified system. The solid phase includes the modified bentonite and nano particles of ZnS. The liquid phase includes a hydrophobic solvent and the oil.

According to an embodiment herein, the two phase system includes a solvent phase and a solid phase to form a heterogeneous system. The solvent phase includes a solvent and oil. The solvent is selected from a group consisting of toluene, hexanes and combination thereof The oil is selected from a group consisting of PCB oil, transformer oil and capacitor oil. The solid phase includes a modified bentonite and metal sulphide particles. The metal sulphide particles are selected from a group consisting of ZnS and CdS. The metal sulphide particles are immobilized on the surface of modified bentonite.

According to the embodiments herein, a new technique of immobilization of CdS and ZnS nano-particles on the surface of modified bentonite is presented in a procedure that is principally similar to reverse micelles. Bentonite is first treated with an aqueous solution of hexadecyl trimethyl ammonium bromide (HDTMAB) at room temperature, resulting in the formation of HDTMA exchanged bentonite, referred to as ‘modified bentonite’. It is assumed that this modified bentonite has a hydrophobic nature. Then, the modified bentonite is dispersed in cyclohexane as a nonpolar medium, and aqueous solutions of Cadmium Nitrate [Cd(NO₃)₂] or Zinc Nitrate [Zn(NO₃)₂] and Sodium sulfide [Na₂S] are added alternately at room temperature for a period of 24 h, thereby forming nano-particles of CdS or ZnS immobilized on the bentonite surface.

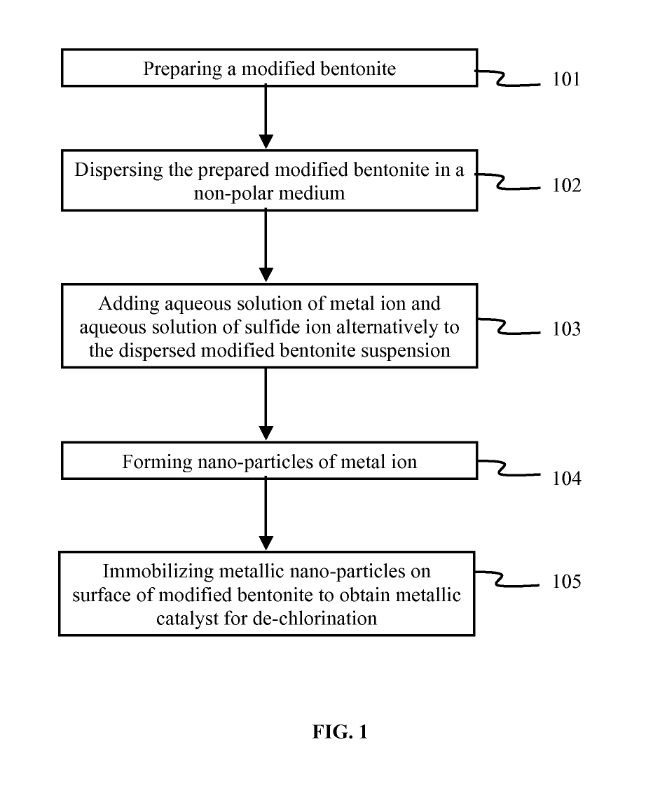

FIG. 1 illustrates a flow chart indicating the steps for the method of preparation of a nano-material for dechlorination of polychlorobiphenyls (PCB) from oil, according to an embodiment herein. With respect to FIG.1, a modified bentonite is prepared (101) and then the prepared modified bentonite is dispersed in a non-polar medium (102). An aqueous solution of metal ion and aqueous solution of sulfide ion are added alternatively to the dispersed modified bentonite suspension at room temperature for 24 h (103). Nano-particles are formed (104). The nano particles are immobilized on the surface of a modified bentonite to obtain a metallic catalyst for dechlorination of PCB in oils (105).

The modified bentonite is prepared by treating a Na-bentonite with an aqueous solution of a surfactant at room temperature. The surfactant is hexadecyl pyridinium bromide (HDPB) and hexadecyl trimethyl ammonium bromide (HDTMAB), wherein hexadecyl pyridinium bromide is more preferable. The non-polar medium is cyclohexane. The aqueous solution of metal ion is Cadmium Nitrate or Zinc Nitrate, wherein zinc nitrate is more preferable. The aqueous solution of sulfide ion is Sodium sulfide [Na₂S]. The nano-particles of metal sulphides are ZnS and CdS nano-particles immobilized on a surface of modified bentonite.

According to an embodiment herein, the nano-material for dechlorination of polychlorobiphenyls (PCB) from oil includes mixing oil, the nano-material and a solvent. Irradiating the mixture under ultraviolet rays for 2-6 h. The oil herein is selected from a group consisting of PCB oil, transformer oil and capacitor oil. The solvent herein is toluene.

According to one embodiment herein, a heterogeneous system includes a solvent phase having a solvent and oil and a solid phase having modified bentonite and nano or microscale sulphide particles. The solvent is toluene, hexanes or the like. Heterogeneous catalysts or systems act in a different phase than the reactants. Most heterogeneous catalysts are solids that act on substrates in a liquid or gaseous reaction mixture. Diverse mechanisms for reactions on surfaces are known, depending on how the adsorption takes place. The total surface area of solid has an important effect on the reaction rate. The smaller the catalyst particle size, the larger the surface area for a given mass transfer. In a heterogeneous reaction such as dechlorination of PCBs the nano-size catalysts (ZnS or CdS) are dispersed on the surface of the modified bentonite to increase the surface area of the catalyst and more importantly, lower the possibility of sintering of the catalyst. In such systems, solvent desorbs products from the active sites, and make room for new reaction on the surface of the catalyst. As a matter of fact, solvent takes off the heat of the reaction from the “hot” active sites where the reaction occurs.

According to the embodiments herein, an emulsified system consisting of a hydrophobic solid support containing nano-scale zinc or cadmium sulfide particles dispersed on the surface of a support, wherein the hydrophobic nature of the organo-bentonite draws PCBs through the solvent-surfactant to the surface of the bentonite. Once inside the modified bentonite, PCBs diffuse to the excited sulphide nanoparticles and undergo degradation. The PCBs continue to enter, diffuse and degrade and the biphenyl or other benign by-products exit the particles maintaining a concentration gradient across the organo-bentonite and maintaining a driving force of the reaction. The chlorinated biphenyls combine with electrons from the conduction bands of the nano-catalysts to form corresponding radical anions and toluene transfers its electrons to the holes formed in the valence bands of nano-catalysts under UV light irradiation. Hydrogen atoms, which replace chlorine atoms, come from toluene.

According to an embodiment herein, modifying the Na-bentonite with a monolayer surfactant, the surface of the bentonite becomes hydrophobic in nature. Therefore, by suspending the modified bentonite in an organic solvent such as cyclohexane, and then adding water to this mixture, water molecules try to find a site on the surface of the bentonite, especially in places where electrostatic charges exist. One would expect that these electrostatic charges develop where the negative charges of the surface have interaction with the polar head of the surfactant. By adding water to the suspended bentonite in cyclohexane, separate water pools are expected to be created on the surface. This system is somewhat similar to a reverse micelle system. Therefore, by adding the precursors of the CdS or ZnS to this mixture, they are expected to gather together in these pools and form CdS or ZnS particles. The size of the created water pools exclusively determines the size of the precipitated particles.

The Organo-clay is manufactured by modifying Na-bentonite with quaternary ammonium salts, a type of surfactant that contains a nitrogen ion. The nitrogen end of the quaternary amine, the hydrophilic end, is positively charged, and ion exchanges onto the clay platelet for sodium. The amine used is of the long chain type with 12-18 carbon atoms. After some 30 wt % of the clay surface is coated with these amines it becomes hydrophobic. The preferred surfactant in the embodiments herein is hexadecyl pyridinium bromide (HDPB). The main component of organo-clay herein is bentonite.

Bentonite is a chemically altered volcanic ash that consists primarily of the clay mineral montmorillonite. Bentonite in its natural state can absorb up to seven times of its weight in water, after treatment can absorb only 5-10% of its weight in water, but 40-70% in oil, grease, and other sparingly-soluble, hydrophobic chlorinated hydrocarbons.

According to an embodiment herein, the sulphide nano-material can decompose PCBs at room temperature and use the residual oil. The starting oil is viscous and to improve the contact between the chlorinated hydrocarbon and the nano-catalyst a solvent such as toluene is used.

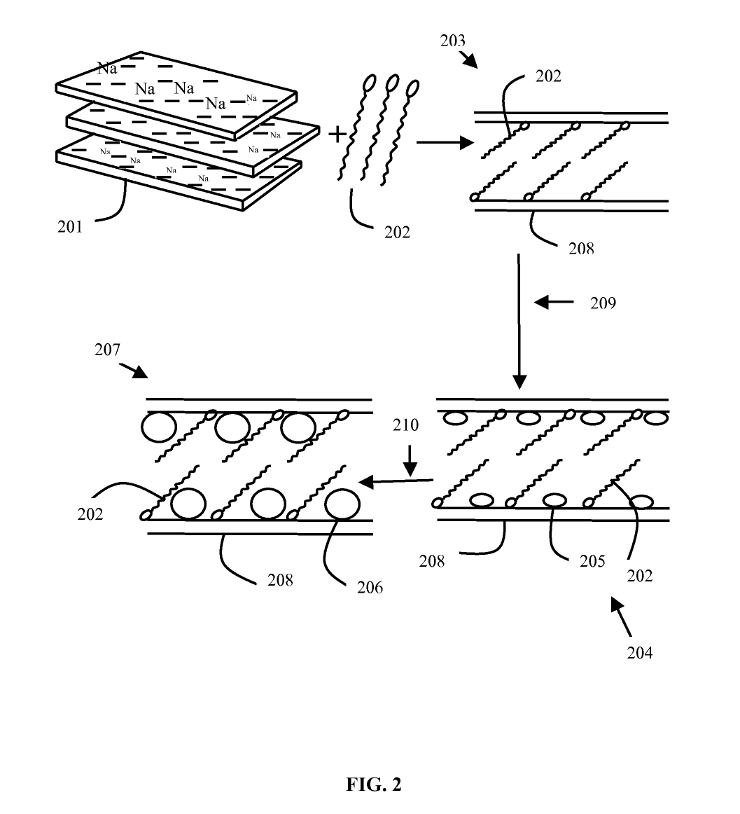

FIG. 2 illustrates a step by step diagrammatic representation of the formation of ZnS nano-particles on the surface of modified bentonite, according to an embodiment herein. With respect to FIG. 2, Na-bentonite 201 is treated with surfactant molecules 202 to form a modified bentonite or modified clay 203. The surfactant molecules 202 get arranged between the layers 208 of the Na-bentonite 201. Then, an aqueous solution of Zn(NO₃)₂ 209 is added to the modified bentonite 203 to form a Zn-bentonite composite 204. In Zn-bentonite composite 204, the Zinc ions 205 get arranged in between the surfactant molecules 202 and in between the layers 208 of Na-bentonite. Then, an aqueous solution of Na₂S 210 is added to Zn-bentonite composite 204 forming a modified Zinc sulphide-bentonite composite 207. The Zn ions react with the Sulphide ions to form ZnS nano-particles 206 and the ZnS nano-particles 206 get arranged in between the surfactant molecules 202 and between the layers of Na-bentonite 208.

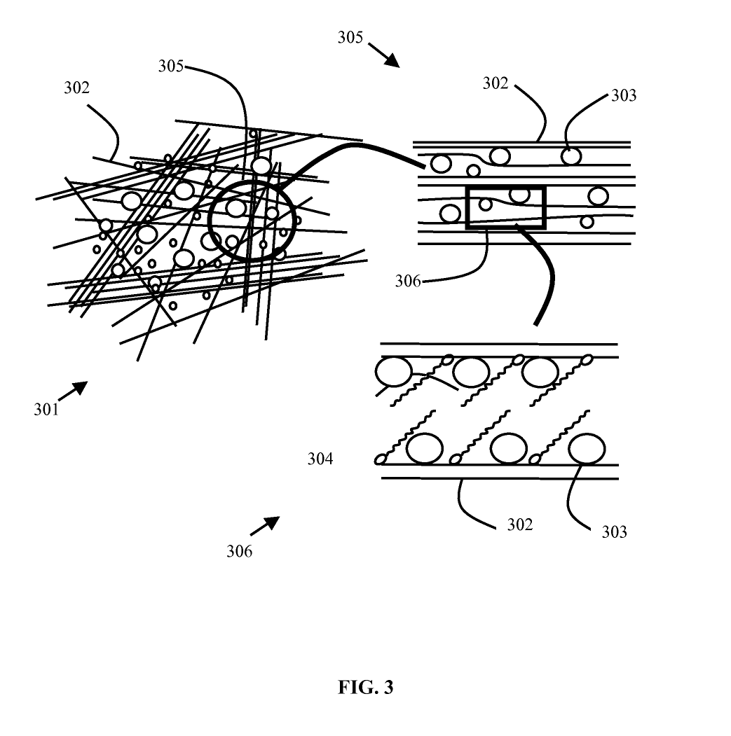

FIG. 3 illustrates a sectional view of the modified bentonite with metal ion and surfactant molecules, according to an embodiment herein. With respect to FIG. 3, the modified bentonite 301 has bentonite layers 302 arranged in random manner. The 305 is an enlarged view of a portion of the modified bentonite 301. With respect to 305, the ZnS nano-particles 303 are arranged in between the layers 302 of modified bentonite. The 306 is further an enlarged view of a portion of 305. With respect to 306, the arrangement of surfactant molecules 304 and ZnS nano-particles 303 in between the layers 302 of modified bentonite can be clearly seen.

The cation-exchange capacity (CEC) of the Na-bentonite is 0.70 meq g⁻¹ as measured by the standard methods. Hexadecyl pyridinium bromide (HDPB) surfactant (from Merck, Germany) is used as received.

According to an embodiment herein, Na-bentonite suspensions were prepared by dispersing 5 g of dried bentonite in 250 mL of bidistilled water to swell the bentonite. To obtain bentonite with monolayer surfactant coverage the Na-bentonite was modified with HDPB solutions (cmc=10⁻³ mol L⁻¹) with concentration below cmc (5×10⁻⁴ mol L⁻¹). For preparation of modified bentonite, 1 g of Na-bentonite was dispersed in 100 mL of HDPB solution (20% w/w ethanol-water, pH=6). The dispersion was stirred at 200 rpm for 48 h and centrifuged. The solid was washed with water to remove excess surfactant and surfactant loosely attached to the bentonite particles.

In an experiment to prepare CdS-bentonite or ZnS-bentonite composite, 500 mg of the modified bentonite was dispersed in 100 mL of cyclohexane, to which Cd(NO₃)₂ (0.1 μmol) or Zn(NO₃)₂ (0.1 μmol) and Na₂S (0.1 μmol) aqueous solutions were added alternately and in this order to the suspension for 24 h, under vigorous stirring. The resulting product was separated via centrifugation, and was washed a few times with distilled water. The product was vaccum dried at room temperature before characterization and photocatalytic activity measurements.

The resulting nano-particles were characterized by X-ray diffraction (XRD), scanning electron microscopy (SEM), transmission electron microscopy (TEM) and atomic force microscopy (AFM).

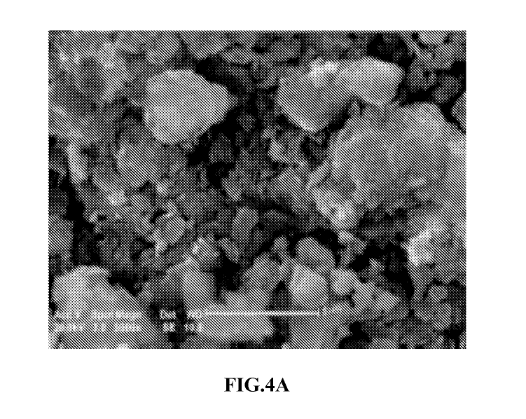

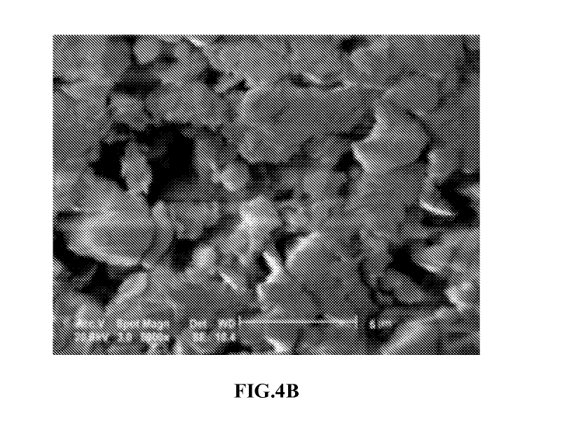

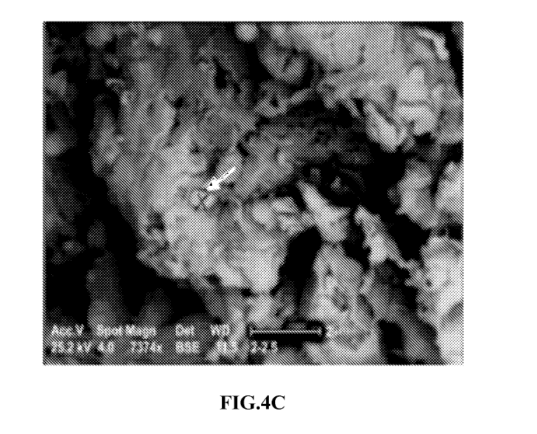

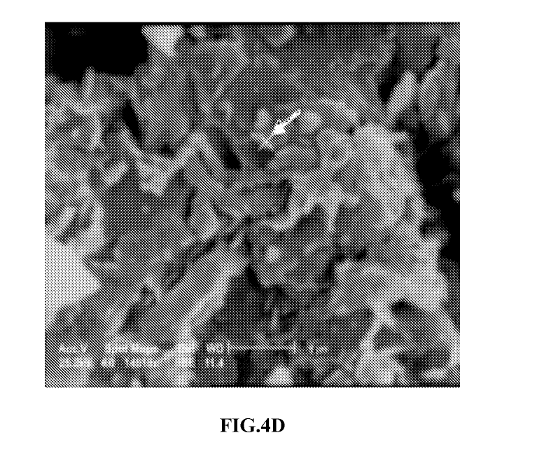

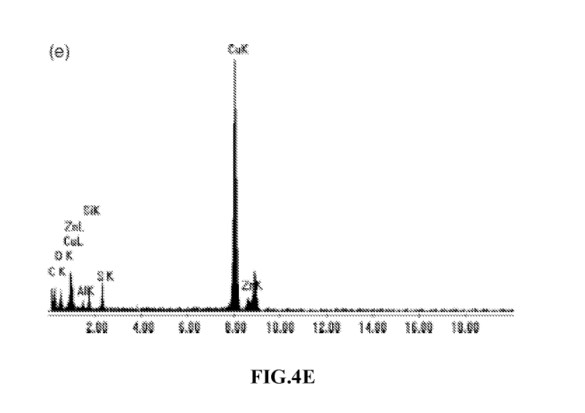

FIG. 4A shows a Scanning electron microscopic (SEM) micrograph of parent bentonite, according to an embodiment herein. With respect to FIG. 4A, the particles of bentonite can be seen. FIG. 4B shows a SEM micrograph of bentonite modified with a monolayer of a surfactant (BMS), according to an embodiment herein. FIG. 4C shows a SEM micrograph of Zinc Sulphide nanoparticles-bentonite composite, according to an embodiment herein. With respect to FIG. 4B, the arrow indicates the ZnS nano-particle. FIG. 4D shows a SEM micrograph of Zinc Sulphide nanoparticles-bentonite composite, according to an embodiment herein. With respect to FIG. 4D, the arrow indicates the ZnS nano-particle. FIG. 4E shows an Energy-dispersive X-ray spectroscopy (EDS) spectrum of prepared modified bentonite with Zinc Sulphide nano-particles and surfactant. With respect to FIG. 4E, the presence of Zn and S is confirmed.

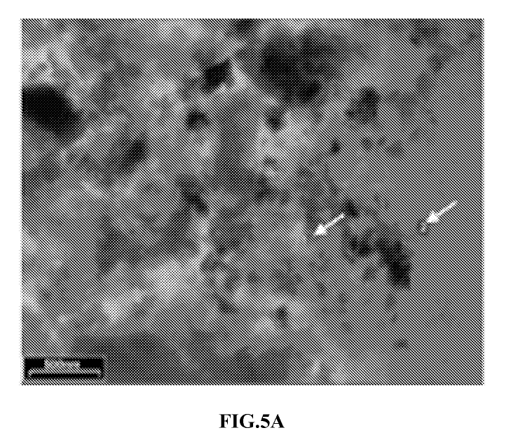

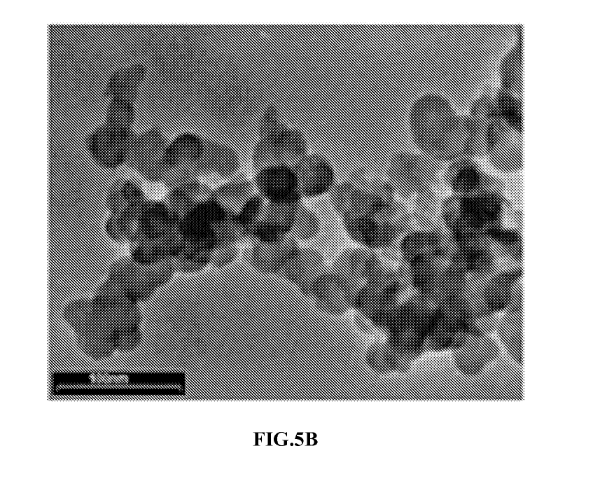

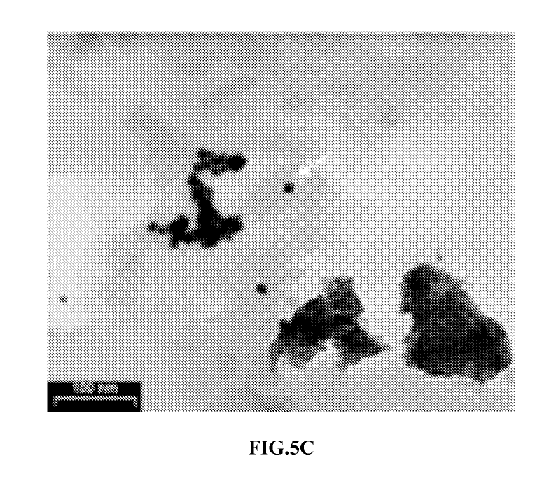

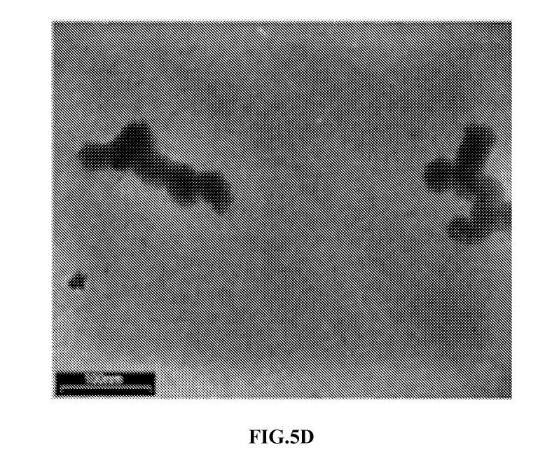

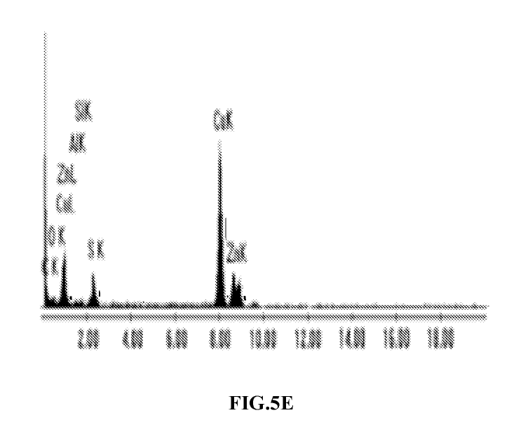

FIG. 5A shows a transmission electron microscopy (TEM) micrograph of Zinc sulphide modified bentonite, as an embodiment herein. With respect to FIG. 5A, the arrows indicate the Zinc sulphide nano-particle on modified bentonite. FIG. 5B shows a TEM micrograph of Zinc sulphide modified bentonite, as an embodiment herein. FIG. 5C shows a TEM micrograph of Zinc sulphide modified bentonite, as an embodiment herein. With respect to FIG. 5C, the arrow indicates the Zinc sulphide nano-particle on the modified bentonite. FIG. 5D shows a TEM micrograph of Zinc sulphide modified bentonite, as an embodiment herein. FIG. 5E shows an EDS spectrum of Zinc sulphide modified bentonite, as an embodiment herein. With respect to FIG. 5E, the presence of Zn and S is confirmed.

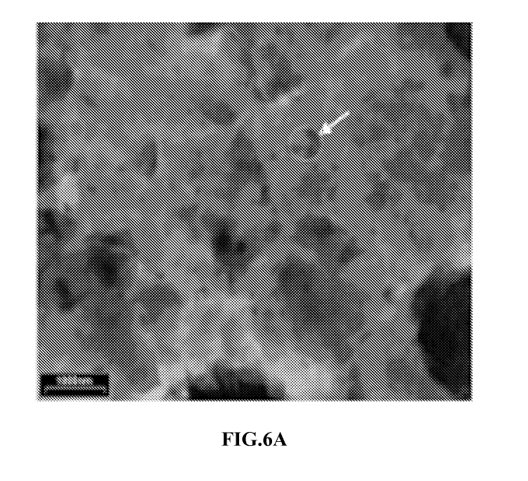

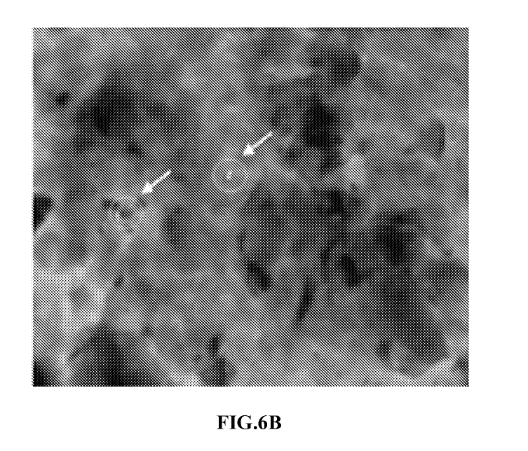

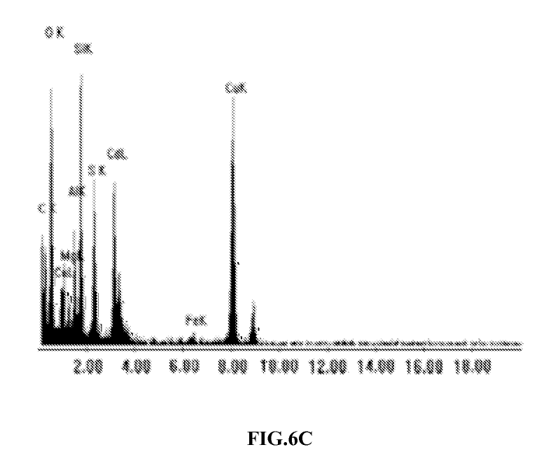

FIG. 6A shows a TEM micrograph of Cadmium sulphide modified bentonite, as an embodiment herein. With respect to FIG. 6A, the arrow indicates the Cadmium sulphide nano-particle on the modified bentonite. FIG. 6B shows a TEM micrograph of Cadmium sulphide modified bentonite, as an embodiment herein. With respect to FIG. 6B, the arrows indicate the Cadmium sulphide nano-particles on the modified bentonite. FIG. 6C shows an EDS spectrum of Cadmium sulphide modified bentonite, as an embodiment herein. With respect to FIG. 6C, the presence of Cd and S is confirmed.

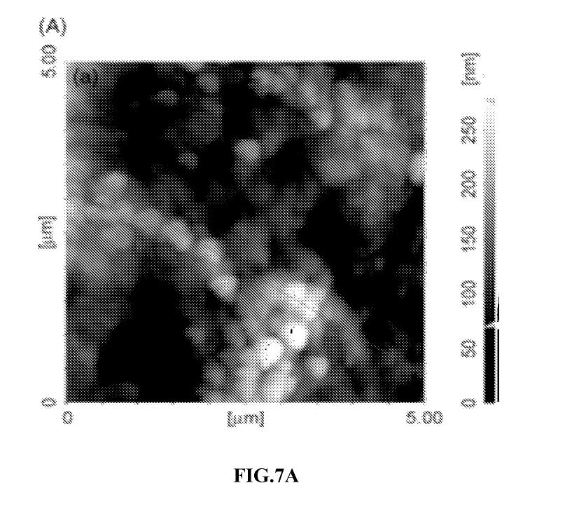

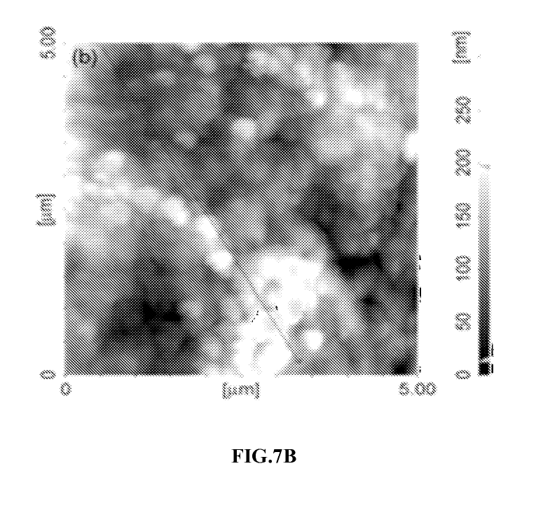

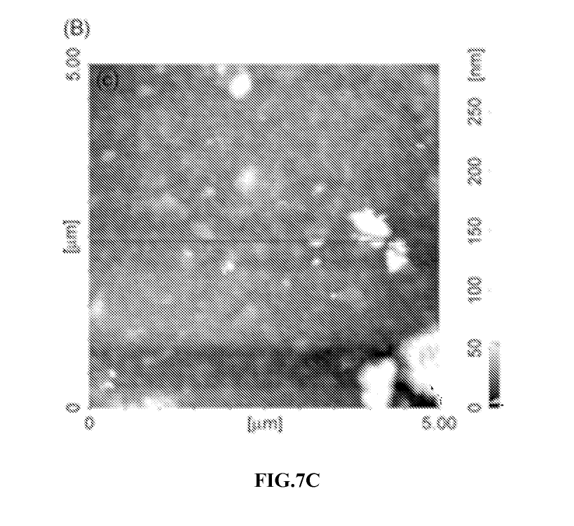

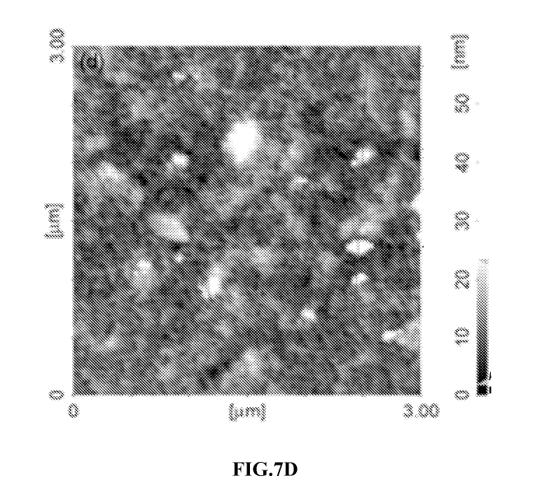

FIG. 7A shows an Atomic force microscopy (AFM) image of Zinc sulphide nano-particles immobilized on the surface of modified bentonite, as an embodiment herein. With respect to FIG. 7A, the highest point on the map is about 250 nm. FIG. 7B shows an AFM image of Zinc sulphide nano-particles immobilized on the surface of modified bentonite, as an embodiment herein. With respect to FIG. 7B, the highest point on the map is about 300 nm. FIG. 7C shows an AFM image of cadmium sulphide nano-particles immobilized on the surface of modified bentonite, as an embodiment herein. With respect to FIG. 7C, the highest point on the map is about 80 nm. FIG. 7D shows an AFM image of cadmium sulphide nano-particles immobilized on the surface of modified bentonite, as an embodiment herein. With respect to FIG. 7D, the highest point on the map is about 50 nm.

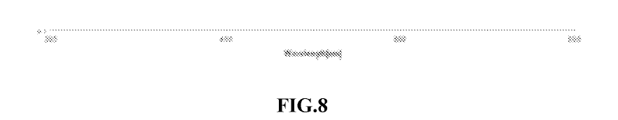

FIG. 8 shows a UV-Visible spectra of bentonite, Zinc sulphide bentonite and Cadmium bentonite, as an embodiment herein, wherein (a) is bentonite, (b) is Zinc sulphide bentonite and (c) is Cadmium bentonite. With respect to FIG. 8, the Zinc sulphide bentonite shows similar spectra to bentonite.

The catalytic behavior of these nano-particles immobilized onto the bentonite was analyzed by the photocatalytic degradation of polychlorinated biphenyls under UV irradiation. A 400 W high pressure Hg lamp (340 nm, Wacon, UK, BMO-500DY) was used as the light source. The experiment to degrade PCBs with immobilized CdS or ZnS on bentonite catalyst were carried out in a 100 mL Pyrex Morton flask equipped with a magnetic stirrer. 0.5 g of the catalyst powder, 2 mL of contaminated oil and 20 mL toluene were loaded into the flask to form a suspension under stirring. The suspension was irradiated with a UV lamp for various times. The concentration of the residual PCBs was measured using a UV-visible spectrophotometer model JASCO (Japan) V-570 at the wavelength of 517 nm after separation of the catalyst from the mixture by filtration. The treatment time was generally 3-6 h, preferably 6 h.

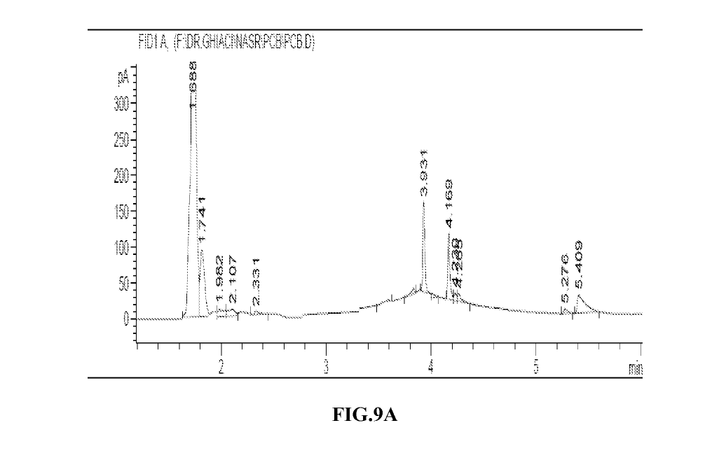

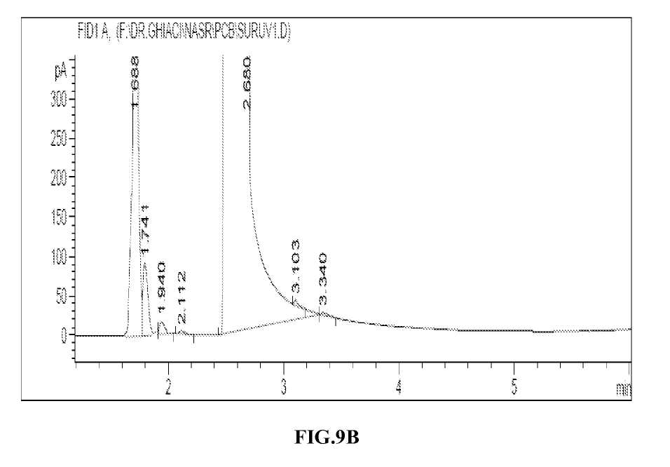

FIG. 9A shows a chromatograph of one test mixture of the oil containing polychlorinated biphenyls. FIG. 9B shows a chromatograph of one test mixture after exposing to the Zinc sulphide nano-particles in the presence of UV light. With respect to FIG. 9A and FIG. 9B, the highest peak of 2.680 can be seen in chromatograph after giving UV radiation. This shows the degradation of PCB from the oil.

The embodiments herein are supported with following examples. The examples set forth are not meant to limit the scope in any manner.

### EXAMPLE 1

### Blank Reaction 1

A mixture of 1,2,4,5-tetrachlorobenzene (0.2 g, contains 65.74 wt % Cl), modified bentonite containing ZnS nano-particles (0.5 g), and 20 mL toluene were introduced into a 50 mL Morton flask equipped with a magnetic stirrer and a condenser. The suspension was irradiated with a UV lamp (a 200 W, high pressure Hg lamp, 340 nm) for a period of 6 h. The catalyst was separated by filtration, and the concentration of the released chlorine as chloride ion was measured using the standard methods. The amount of chlorine in the organic phase was less than 5 wt percent of the chlorine in the original compound.

### EXAMPLE 2

### Blank Reaction 2

The procedure of example 1 was repeated using 0.2 g of a standard sample (Aroclor 1242, contains 52 wt % CO. The suspension was irradiated with a UV lamp (a 200 W, high pressure Hg lamp, 340 nm) for a period of 6 h. The catalyst was separated by filtration, and the concentration of the released chlorine as chloride ion was measured using standard methods. The amount of chlorine in the residual Aroclor was less than 3 wt % of the chlorine in the original sample.

### EXAMPLES 3-6

The procedure of example 1 was repeated using 0.2, 1.0, 2.0, and 3.0 g of Askaral oil containing PCBs. In these experiments the amount of catalyst (0.5 g), and the amount of solvent (20 mL) were the same as the example 1. The suspensions were irradiated with UV lamp (a 200 W, high pressure Hg lamp, 340 nm) for a period of 3 h. The catalyst was separated by filtration, and the concentration of the released chlorine as chloride ion was measured using standard methods. Data are summarized in Table 1. On the basis of these data, use of 0.2 g Askaral oil is preferred, when 0.5 g of the catalyst, and 20 mL of toluene were applied.

TABLE 1
Effect of the amount of Askaral oil

| | Amount of Askaral oil | Measured chloride ion |
|---|---|---|
| Entry | (g) | (ppm) |
| 1 | 0.2 | 1.72 ± 0.1 |
| 2 | 1 | 1.84 ± 0.1 |
| 3 | 2 | 3.48 ± 0.1 |
| 4 | 3 | 6.09 ± 0.1 |

Reaction conditions: 0.5 g of the catalyst, 20 mL toluene, irradiation time, 3 h.

### EXAMPLES 7-10

The procedure of example 1 was repeated using 0.5, 1.0, 1.5, and 2.0 g of the catalyst. In these experiments the amount of Askaral oil (0.5 g), and the amount of solvent (20 mL) were the same as the example 1. The suspensions were irradiated with UV lamp (a 200 W, high pressure Hg lamp, 340 nm) for a period of 3 h. The catalyst was separated by filtration, and the concentration of the released chlorine as chloride ion was measured using standard methods. Data are summarized in Table 2. On the basis of these data, 0.5 g catalyst was used, when 0.2 g of Askaral oil, and 20 mL of toluene were applied.

TABLE 2
Effect of the amount of catalyst

| | Amount of catalyst | Measured chloride on |
|---|---|---|
| Entry | (g) | (ppm) |
| 1 | 0.5 | 1.72 ± 0.1 |
| 2 | 1 | 1.89 ± 0.1 |
| 3 | 1.5 | 3.12 ± 0.1 |
| 4 | 2 | 7.20 ± 0.1 |

Reaction conditions: 0.2 g of Askaral oil, 20 mL toluene, irradiation time, 3 h.

### EXAMPLES 11-13

The procedure of example 1 was repeated using different time of irradiation. In these experiments, a mixture of Askaral oil (0.2 g), modified bentonite containing ZnS nano-particles (0.5 g), and 20 mL toluene were introduced into a 50 mL Morton flask equipped with a magnetic stirrer and a condenser. The suspension was irradiated with a UV lamp (a 200 W, high pressure Hg lamp, 340 nm) for different times. The catalyst was separated by filtration, and the concentration of the released chlorine as chloride ion was measured using the standard methods. Data are summarized in Table 3. On the basis of these data, in the optimum condition the sample is irradiated for a period of 6 h, when 0.2 g of Askaral oil, 0.5 g of the catalyst, and 20 mL of toluene were applied.

TABLE 3
Effect of the irradiation time

| | Time of | Measured chlorine in |
|---|---|---|
| Entry | irradiation (h) | the residual oil* |
| 1 | 2 | 9.32 ± 0.1 |
| 2 | 4 | 1.02 ± 0.1 |
| 3 | 6 | 0.015 |

Reaction conditions: 0.2 g of Askaral oil, 20 mL toluene, 0.5 g of the catalyst
*the amount of chlorine was measured by using sodium

### EXAMPLES 14-16

The procedure of example 1 was repeated using 0.2 g of the Askaral oil, 0.5 g of the catalyst, and 20 mL of toluene as solvent. In these experiments the amount of nano-catalyst immobilized on the surface of bentonite was optimized. The suspension was irradiated with a UV lamp (a 200 W, high pressure Hg lamp, 340 nm) for a period of 3 h. The catalyst was separated by filtration, and the concentration of the released chlorine as chloride ion was measured using the standard methods. Data are summarized in Table 4. On the basis of these data, the sample is irradiated for a period of 6 h, when 0.2 g of Askaral oil is applied, and 0.5 g of the catalyst, which contains 0.02 wt % of the nano-catalyst, and 20 mL of toluene, as the best reaction condition. The data shows that by increasing the weight percent of the metal sulfide, the particles aggregate on the surface of bentonite and the sulfide loses its efficiency.

TABLE 4
Effect of the weight percent of nano-catalyst
immobilized on bentonite

| | Wt. % of the | Measured chloride ion |
|---|---|---|
| Entry | nano-catalyst | (ppm) |
| 1 | 0.02 | 1.72 ± 0.1 |
| 2 | 0.2 | 3.25 ± 0.1 |
| 3 | 2 | 9.75 ± 0.1 |

Reaction conditions: 0.2 g of Askaral oil, 0.5 g of the catalyst, 20 mL toluene, irradiation time, 3 h.

### EXAMPLES 17-18

The procedure of example 1 was repeated using 0.2 g of the Askaral oil, 0.5 g of the catalyst, and 20 mL of toluene as solvent. The suspension was irradiated with a UV lamp (a 200 W, high pressure Hg lamp, 340 nm) for a period of 3 h. The catalyst was separated by filtration, and the concentration of the released chlorine as chloride ion was measured using the standard methods. Data are summarized in Table 5. On the basis of these data, in an optimum condition, the sample was irradiated for a period of 3 h, when applying 0.2 g of Askaral oil, 0.5 g of the catalyst, which contains 0.02 wt % of the nano-catalyst, and 20 mL of toluene. The data shows that the ZnS nano-catalyst has a more efficacy for dechlorination of PCBs in the oils.

TABLE 5
Effect of the type of nano-catalyst

| | | Measured chloride |
|---|---|---|
| Entry | Type of nanocatalyst | ion (ppm) |
| 1 | ZnS | 1.85 ± 0.1 |
| 2 | CdS | 5.73 ± 0.1 |

Reaction conditions: 0.2 g of Askaral oil, 0.5 g of the catalyst, 20 mL toluene, irradiation time, 3 h.

Although the embodiments have been described in some detail by way of illustration and example for the purposes of clarity of understanding, it is clearly not limited thereby and this invention encompass any changes and modifications that may be practiced within the scope of the appended claims by ones skilled in the art.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

What is claimed is:

1. A method of preparation of a sulphide nano-material for dechlorination of polychlorobiphenyls (PCB) from an oil comprising the steps of:
preparing a modified bentonite at a preset temperature and wherein the preset temperature is room temperature;
dispersing the prepared modified bentonite in a non-polar medium;
adding an aqueous solution of a metal ion and an aqueous solution of a sulphide ion alternatively to the dispersed modified bentonite suspension at a given temperature for a preset period and wherein the given temperature is a room temperature and wherein the preset period is 24 h;
forming nano-particles of metal sulphide wherein the nanoparticles are formed and immobilized on a surface of the modified bentonite.

2. The method according to claim 1, wherein the modified bentonite is prepared by treating a Na-bentonite with an aqueous solution of a surfactant at room temperature.

3. The method according to claim 2, wherein the surfactant is selected from a group consisting of hexadecyl pyridinium bromide and hexadecyl trimethyl ammonium bromide and wherein the surfactant is hexadecyl pyridinium bromide.

4. The method according to claim 1, wherein the non-polar medium is cyclohexane.

5. The method according to claim 1, wherein the metal ion is selected from a group consisting of Cadmium Nitrate and Zinc Nitrate, wherein the metal ion is Zinc Nitrate.

6. The method according to claim 1, wherein the sulphide ion is Sodium Sulphide.

7. The method according to claim 1, wherein the nano-particles of metal sulphide are selected from a group consisting of nano particles of ZnS and nano-particles of CdS, wherein the nano-particles of metal sulphide are ZnS nanoparticles.

8. A method for reductive chlorination of polychlorobiphenyls (PCB) from an oil, the method comprising the steps of:
preparing a metallic catalyst and wherein the metallic catalyst is nanoparticles of ZnS immoblised on a modified bentonite surface;
mixing the metallic catalyst, a solvent and the oil to be reductively chlorinated to form a suspension; and
irradiating the suspension for a given time and wherein the given time is for 2-6 h.

9. The method according to claim 8, wherein the step of irradiating the suspension involves irradiating the suspension using an ultraviolet light and wherein the suspension is irradiated using an ultraviolet lamp.

10. The method according to claim 8, wherein the oil is selected from a group consisting of PCB oil, transformer oil and capacitor oil.

11. The method according to claim 8, wherein the metallic catalyst is a Zinc sulphide nano-particle immobilized on a modified bentonite surface.

12. The method according to claim 8, wherein the solvent is toluene.

13. The method according to claim 8, wherein the metallic catalyst is reused for 2-3 times before being disposed of

14. The method according to claim 8 further comprising a step of applying a two phase system to destroy PCB from an oil mixture.

15. The method according to claim 14, wherein the two phase system includes a solid phase and a liquid phase to form an emulsified system.

16. The method according to claim 15, wherein the solid phase includes the modified bentonite and nano particles of ZnS and wherein the liquid phase includes a hydrophobic solvent and the oil.

17. The method according to claim 14, wherein the two phase system includes a solvent phase and a solid phase to form a heterogeneous system.

18. The method according to claim 17, wherein the solvent phase includes a solvent and oil and wherein the solvent is selected from a group consisting of toluene, hexanes and combination thereof and wherein the oil is selected from a group consisting of PCB oil, transformer oil and capacitor oil.

19. The method according to claim 17, wherein the solid phase includes a modified bentonite and metal sulphide particles and wherein the metal sulphide particles are selected from a group consisting of ZnS and CdS.

20. The method according to claim 19, wherein the metal sulphide particles are immobilized on the surface of modified bentonite.
